(19) United States
(12) Patent Application Publication
(10) Pub. No.: US 2011/0078025 A1
(43) Pub. Date: Mar. 31, 2011

(54) REAL TIME AUTHENTICATION OF PAYMENT CARDS

(76) Inventor: Shourabh Shrivastav, Karnataka (IN)

(21) Appl. No.: 12/997,571

(22) PCT Filed: Jun. 11, 2009
(86) PCT No.: PCT/IN2009/000338

§ 371 Date: Dec. 10, 2010

(30) Foreign Application Priority Data
Jun. 13, 2008 (IN) 1434/CHE/2008

(51) Int. Cl. G06Q 40/00; G06Q 30/00

(52) U.S. Cl. 705/14.64; 705/44

(57) ABSTRACT

An authentication sever (108) to authenticate real time a transaction associated with an electronic card performed by a user 102 subscribed to an authentication service having a user subscription database (202) on the authentication server 108 is provided. The authentication server (108) executes including obtaining a confirmation that the user (102) is subscribed to the authentication service, generating a verification code real time triggered by the transaction associated with the electronic card, communicating the verification code to a mobile communication device (104 A-B) associated with the user, processing a verification message based on the verification code and a mobile communication device information associated with the mobile communication device (104 A-B), and authenticating the transaction if the verification message and the mobile communication device information matches an information associated with the user subscription database. The verification message and the mobile communication device information are obtained from the mobile communication device (104A-B) real time.

### BACKGROUND

1. Technical Field

The embodiments herein generally relate to payment cards, and, more particularly, to real time authentication of payment cards.

2. Description of the Related Art

Technology has revolutionized the way that consumers make purchases including traditional face-to-face purchases and non-face-to-face purchases (e.g., via internet or telephone). With the introduction of ecommerce, consumers can purchase goods and services from a remote merchant via the internet or the telephone. Credit cards and debit cards issued by financial institutions (e.g., banks, etc.) have been the main payment instruments for ecommerce transactions. Credit cards and debit cards enable cashless payment for goods and services at the point of sale. However, credit cards are used widely extensively but always in an appreciation of information being hacked.

Credit card transactions maximize the possibility of fraud (e.g., such as magnetic strip reproduction and card cloning) which has been a major problem in respect of credit cards. Also, credit card transactions via internet are exposed to hacking of credit card details as there may be a presence of credit card details (e.g., the credit card number, validity period, CVV number etc.) on the Internet servers, or located on a user's machine (e.g., cookies). Further, financial institutions have comprehensive fraud detection software and/or measures which can detect frauds but not on real time basis. In fact there is no authentication process for authenticating a transaction of cash withdrawal with an ATM.

Also, conventional methods of financial transaction involving mobile phones require the user to provide bank account number, payment card number, and/or authorization code to a third party service provider, thereby allowing the third party to have access the confidential information associated with the payment card which is again a possibility of risk.

### SUMMARY

In view of the foregoing, an embodiment herein provides a method of authenticating real time a transaction associated with an electronic card. The transaction is performed by a user subscribed to an authentication service having a user subscription database on an authentication server. The method includes obtaining a confirmation that the user is subscribed to the authentication service, generating a verification code real time triggered by the transaction associated with the electronic card, communicating the verification code to a mobile communication device associated with the user, processing a verification message and a mobile communication device information associated with the mobile communication device, and authenticating the transaction if the verification message and the mobile communication device information matches an information associated with the user subscription database. The verification message and the mobile communication device information are obtained from the mobile communication device real time.

A transaction validation message is communicated to a merchant along with a targeted advertisement to the user based on at least one of the user's interest, or a location of usage of the transaction associated with the electronic card, or the user location associated with the user subscription database at the time of subscription to the authentication service. The mobile communication device as a secondary mobile communication device is identified based on a match between a user login information associated with the mobile communication device and a user login information associated with the secondary mobile communication device stored in the user subscription database.

The mobile communication device and the secondary mobile communication device include a client application. The mobile communication device information is at least one of a International Mobile Equipment Identity (IMEI) information, a Subscriber Identity Module (SIM) information, a Bluetooth unique identifier information, a infrared identifier information, or a mobile communication device number.

The electronic card includes at least one of a International Mobile Equipment Identity (IMEI) information, a Subscriber Identity Module (SIM) information, a Bluetooth unique identifier information, a infrared identifier information, or a contact information associated with the mobile communication device. The contact information is a mobile communication device number associated with the user. The mobile communication device and the secondary mobile communication device is at least one of a GSM phone, a UMTS phone, a CDMA phone, a CDMA 2000 phone, a PDC, a TDMA phone, a smart phone, a PDA (Pocket Digital Assistant), a touch sensitive device, a handheld device, or a wireless device.

The verification code and the verification message is communicated via at least one of an SMS channel, an MMS channel, a GPRS data channel, a CDMA data channel, a Bluetooth channel, an infrared channel, an Interactive Voice Response (IVR), or a 3G network.

The transaction associated with the electronic card is one of a face to face transaction or a non face to face transaction. The transaction associated with electronic card is one of a credit card transaction or a debit card transaction. The credit card transaction and the debit card transaction is one of a cash withdrawal transaction with an ATM. The client application associated with the mobile communication device and the secondary mobile communication device sends the mobile communication device information associated with the mobile communication device and the secondary mobile communication device to the authentication server.

In another aspect, a program storage device readable by computer, tangibly embodying a program of instructions executable by the computer to perform a method of authenticating an electronic card transaction real time, the transaction performed by a user subscribed to an authentication service having a user subscription database on the authentication server. The method includes processing a verification code from the authentication server on the transaction being performed, and communicating a verification message based on the verification code and a mobile communication device information associated with a mobile communication device associated with the user on the user subscription database. The verification message and the mobile communication device information are communicated simultaneously to the authentication server real time.

The transaction associated with the electronic card is one of a face to face transaction or a non face to face transaction, the transaction is at least one of a credit card transaction or a debit card transaction. The credit card transaction and the debit card transaction is one of a cash withdrawal transaction with an ATM. The mobile communication device includes a client application. The mobile communication device information is at least one of a International Mobile Equipment Identity (IMEI) information, a Subscriber Identity Module (SIM) information, a Bluetooth unique identifier information, a infrared identifier information, or a contact information associated with the mobile communication device. The contact information is a mobile communication device number associated with the user.

The electronic card includes at least one of a International Mobile Equipment Identity (IMEI) information, a Subscriber Identity Module (SIM) information, a Bluetooth unique identifier information, a infrared identifier information, or a contact information associated with the mobile communication device. The contact information is a mobile communication device number associated with the user.

In yet another aspect, a mobile communication device to perform real time a transaction associated with an electronic card is provided. The mobile communication device includes a client application. The transaction is performed by a user subscribed to an authentication service having a user subscription database on a authentication server. The client application includes a confirmation module to process a verification message on receiving a verification code from the authentication server associated with said mobile communication device and said secondary mobile communication device to said authentication sever real time, and a transmitting module to transmit the verification message and the information associated with the mobile communication device and the secondary mobile communication device simultaneously to the authentication server real time. The information is sent via at least one of an SMS channel, an MMS channel, a GPRS data channel, a CDMA data channel, a Bluetooth channel, an infrared channel, an Interactive Voice Response (IVR), or a 3G network. The IVR is one of a YES/NO response, or a designated key associated with the mobile communication device and the secondary mobile communication device.

The client application further includes a preference module to set a limit associated with the transaction. The transaction is one of a face to face transaction or a non face to face transaction. The transaction is at least one of a credit card transaction or a debit card transaction with an ATM.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 illustrates a system view of a user communicating with a merchant and an authentication server through a network according to an embodiment herein

FIG. 2 illustrates an exploded view of the authentication server of FIG. 1 according to an embodiment herein;

FIG. 3 is a flow diagram illustrating a process at the time of the user of FIG. 1 registering to a service according to an embodiment herein;

FIG. 4 is an interaction diagram of a face-to-face transaction between the user of FIG. 1, and the merchant of FIG. 1 according to an embodiment herein;

FIG. 5 is an interaction diagram illustrating a process of transaction through a Bluetooth mechanism according to an embodiment herein;

FIG. 6A is an interaction diagram of a non face-to-face transaction according to an embodiment herein;

FIG. 6B is an interaction diagram of the user of FIG. 1 performing a transaction with the ATM of FIG. 1 according to an embodiment herein;

FIG. 7 is an interaction diagram between the user of FIG. 1 and the merchant of FIG. 1 illustrating an alternative embodiment of a non-face to face payment according to an embodiment herein;

FIG. 8 is a table view of a database of the payment card according to an embodiment herein;

FIG. 9 is a table view of the database of the authentication server of FIG. 1 according to an embodiment herein;

FIG. 10A through 10E is a user interface view illustrating a method of registering and activating the mobile communication device to perform an electronic card transaction according to an embodiment herein;

FIG. 11A through 11E is a user interface view of the client application of the mobile communication device of FIG. 1 according to an embodiment herein;

FIG. 12 is a process flow illustrating a method authenticating real time a transaction associated with an electronic card performed by the user of FIG. 1 subscribed to an authentication service having a user subscription database on the authentication server of FIG. 1 according to an embodiment herein;

FIG. 13 illustrates an exploded view of the mobile communication device 104A-B of FIG. 1 according to an embodiment herein; and

FIG. 14 illustrates a schematic diagram of a computer architecture used in accordance with the embodiments herein.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

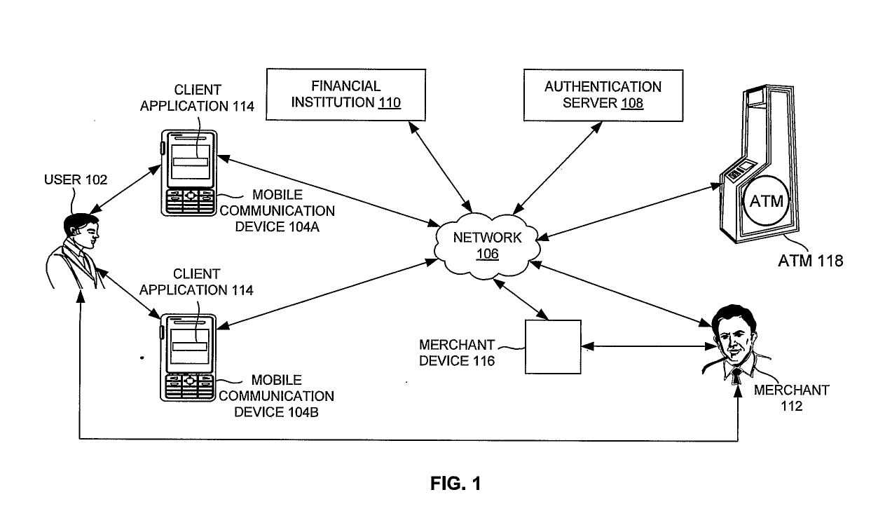

The embodiments herein achieve this by providing a providing an authentication to the payment cards. Referring now to the drawings, and more particularly to FIGS. 1 through 11, where similar reference characters denote corresponding features consistently throughout the figures, there are shown preferred embodiments.

FIG. 1 illustrates a system view of a user 102 communicating with a merchant 112 and an authentication server 108 through a network according to an embodiment herein. The system 100 includes the user 102, a mobile communication device 104A-B, the network 106, the authentication server 108, a financial institution 110, a merchant 112, and an ATM 118. The mobile communication device 104A-B also includes a client application 114. The merchant 112 includes a merchant device 116. The user 102 is associated with a mobile communication device 104A-B. In one embodiment, the mobile communication device 104A may be a primary mobile communication device and the mobile communication device 104B may be a secondary mobile communication device. In another embodiment, the mobile communication device 104B may be a primary mobile communication device and the mobile communication device 104A may be a secondary mobile communication device.

The user 102 may perform a transaction by purchasing a goods or a service from the merchant 112. In one embodiment, the user 102 may perform a transaction with the ATM. The user 102 of the mobile communication device 104A-B receives a SMS message or an IVR (e.g., purchase information, or a transaction information confirmation request) associated to a transaction details. The mobile communication device 104A-B may be a GSM phone, a UMTS phone, a CDMA phone, a CDMA 2000 phone, a PDC, a TDMA phone, a smart phone, a PDA (Pocket Digital Assistant), a touch sensitive device, a handheld device, and/or a wireless device. The mobile communication device 104A-B may receive information (e.g., SMS messages, an Interactive Voice Response (IVR)) related to transactions of the purchases (e.g., a good or a service).

In one embodiment, the mobile communication device 104A-B includes at least one of any International Mobile Equipment Identity (IMEI) information, Subscriber Identity Module (SIM) information, Bluetooth unique identifier information, and contact information. The network 106 may be at least one of an SMS channel, an MMS channel, a GPRS data channel, a CDMA data channel, a Bluetooth channel, an infrared channel, an Interactive Voice Response (IVR) and/or a 3G network. The authentication server 108 may be computer at a remote location.

The authentication server 108 sends and receives a message as an SMS from the mobile communication device 104A-B through the network 106. In one embodiment, the authentication server 108 may communicate via an IVR. The financial institution 110 may issue a payment card (e.g., a credit card, a debit card, etc.) to the user 102. In one embodiment, the payment card may be issued by a non-financial institution. The client. application 114 (e.g., a software) is installed in the mobile communication device 104A-B, when the user 102 subscribes for a service from the authentication server 108.

The payment card may hold information such as IMEI information, contact information, SIM information associated with the mobile communication device 104 of the user 102, and additional information provided by the financial institution 110. In one embodiment, the payment card may also hold a Bluetooth identifier information and an infrared identifier information associated with the mobile communication device 104. The merchant device 116 may be an Electronic Data Capture (EDC) machine. In one embodiment, the merchant device 116 may be a device which can read the payment card (e.g., a credit card, a debit card, etc.) or the Bluetooth unique identifier information of the payment card associated with the mobile communication device 104A-B of the user 102.

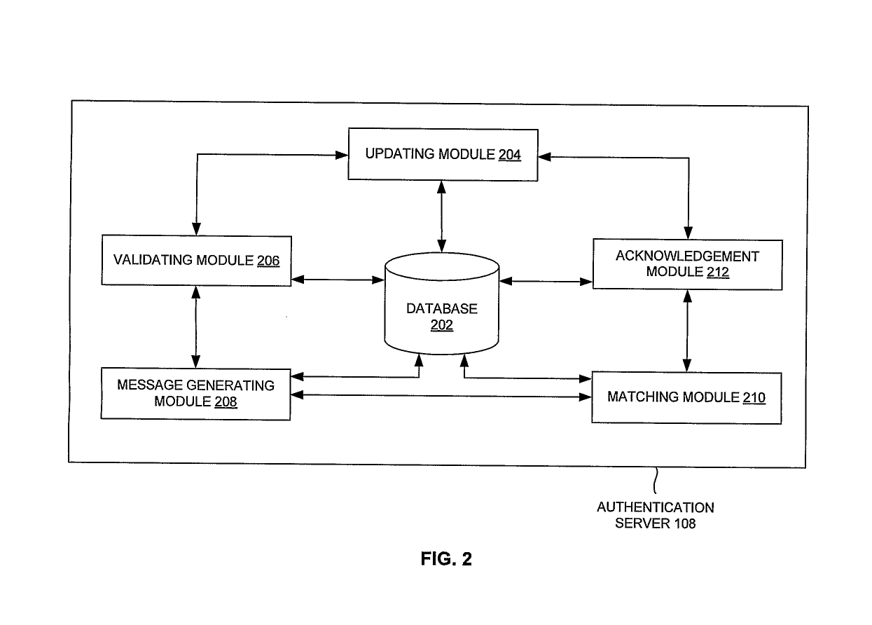

FIG. 2 illustrates an exploded view of the authentication server 108 of FIG. 1 having a database 202, an updating module 204, a validating module 206, a code generating module 208, a matching module 210, and an acknowledgement module 212 according to an embodiment herein. The database 202 contains the IMEI information, the contact information, the Bluetooth unique identifier information, and the SIM information associated with mobile communication device 104A-B of the user 102. The database 202 also includes information associated with the payment card and limit for the transaction. The updating module 204 updates the user information in the database 202. The validating module 206 updates and validates the mobile communication device 104A-B information in the database 202.

The message generating module 208 generates a verification message (e.g., transaction details, and/or a transaction confirmation request) along with a request to enter a

Personal Identification Number (PIN) and sends to the user 102 when the user 102 initiates a transaction (e.g., a face to face transaction and a non-face to face transaction). In one embodiment, the message generating module 208 generates a verification code when a transaction is triggered by the payment card real time. The matching module 210 matches the PIN received from the user 102 with the one stored in the authentication server 108. In one embodiment, the authentication server 108 identifies a transaction performed by the mobile communication device 104A-B. In another embodiment, the matching module 210 identifies the mobile communication device 104B as a secondary mobile communication device based on a match between a user login information associated with the mobile communication device 104B and a user login information associated with the secondary mobile communication device stored in database 202.

In one embodiment, the user 102 may just type a YES/NO response and send to the authentication server 108. In another embodiment, the user 102 may respond via an IVR (e.g., by a speech response (a YES/NO) or by pressing at least one of a designated key on the mobile communication device 104A-B. In yet another embodiment, the user 102 may just type a code and send to the authentication server 108.

The acknowledgement module 112 acknowledges with a validation message to the merchant 112 or the financial institution 110 based on the verification indicating a status of the transaction. In one embodiment, the user 102 purchases a good or a service by making use of the payment card (e.g., the merchant 112 swipes the payment card into the merchant device 116). The merchant device 116 dials the financial institution 110 and may dial the authentication server 108 in parallel.

In one embodiment, the merchant device 116 routes the customer (e.g., the user 102) information to the financial institution 110 and the authentication server 108 (e.g., by swiping a payment card in the Electronic Data Capture (EDC) machine). Then the authentication server 108 generates a verification message and sends to the user 102 requesting the user 102 to enter the PIN by means of a notification (e.g., through the mobile communication device 104A-B).

In one embodiment, the user may not receive a verification message if the transaction amount is less than the prescribed limit. In another embodiment, the notification means may be a SMS channel or a MMS channel, or an IVR, etc. The user 102 then enters the transaction details (e.g., transaction amount, and/or a user PIN) to confirm the purchase order and sends the confirmation message to the authentication server 108.

Simultaneously, the client application 114 sends the IMEI information, SIM information, contact information, and/or a Bluetooth unique identifier information of the mobile communication device associated with the user 102. The authentication server 108 acknowledges with a validation message to the merchant 112 or the financial institution 110 based on the verification indicating a status of the transaction (e.g., transaction completed).

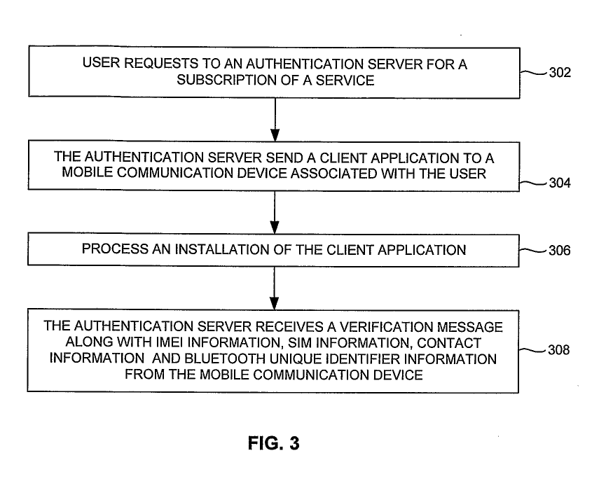

FIG. 3 is a flow diagram illustrating a process at the time of the user 102 of FIG. 1 registering to a service according to an embodiment herein. FIG. 3 illustrates a series of operations carried out during various stages of interaction between the user 102 and the authentication server 108. In operation 302, the user 102 requests to the authentication server 108 for subscribing to a service through the network 106 (e.g., an SMS channel, an MMS channel, a GPRS data channel, a CDMA data channel, and/or a 3G network). In one embodiment, the user 102 may provide a transaction limit (e.g., Rs 5000.00 for a face to face transaction and Rs 3000.00 for non-face to face transaction) for the purchase of a goods and a service at the time of subscribing to a service.

In another embodiment, the user 102 may also provide an option of not receive the verification message from the authentication server 108 if the payment card transaction is less than a prescribed limit (e.g., less than Rs 2000.00). In addition, the user 102 may receive a targeted advertisement (e.g., buying movie tickets, free gift vouchers on shopping, etc.) from the authentication server 108. In one embodiment, the targeted advertisement is delivered to the user 102 on the mobile communication device 104A-B after the transaction associated with the payment card is completed. In another embodiment, the targeted advertisement may be delivered based on user's interest. In yet another embodiment, the targeted advertisement may be delivered based on user's location. For example, the user's location is determined at the time of payment card transaction.

In operation 304, the authentication server 108 sends the client application 114 to the mobile communication device 104A-B associated with the user 102. The client application may be a software application. In one embodiment, the mobile communication device 104A-B must have some provision for downloading the client application 114. In another embodiment, the client application 114 is sent through an SMS channel. In yet another embodiment, the user 102 may download the client application 114 on the mobile communication device 104A-B through internet (e.g., by connecting a data cable to the mobile communication device 104A-B), or Bluetooth.

In operation 306, an installation of the client application 114 is processed on the mobile communication device 104A-B. In operation 308, a confirmation is sent by the user 102 to the authentication server 108. Simultaneously, the client application 112 residing on the mobile communication device 104A-B automatically sends the IMEI information, the SIM information, Bluetooth unique identifier information, and/or the contact information associated with the mobile communication device 104A-B of the user 102 to the authentication server 108. The information associated with the mobile communication device 104 may be sent via SMS channel or a GPRS channel (e.g., internet).

In one embodiment, the client application 114 may send the IMEI information, the Bluetooth unique identifier information, and the contact information. In another embodiment, the client application 114 may send the SIM information, the Bluetooth unique identifier information, and the contact information. In addition, the user 102 may register to the service for a secondary mobile communication device (e.g., in the event if the primary mobile communication device is not available). In one embodiment, the user 102 registers to the service for the secondary mobile communication device (e.g., the mobile communication device 104B of FIG. 1) if the primary mobile communication device (e.g., the mobile communication device 104A of FIG. 1) is lost, the battery of the mobile communication device 104A is drained or low, or if the network is low. Similar process is performed for registering and activating the secondary mobile communication device 104B. The secondary mobile communication device 104B may send and receive messages to process transactions for the purchase of goods and services after activating the secondary mobile communication device 104B.

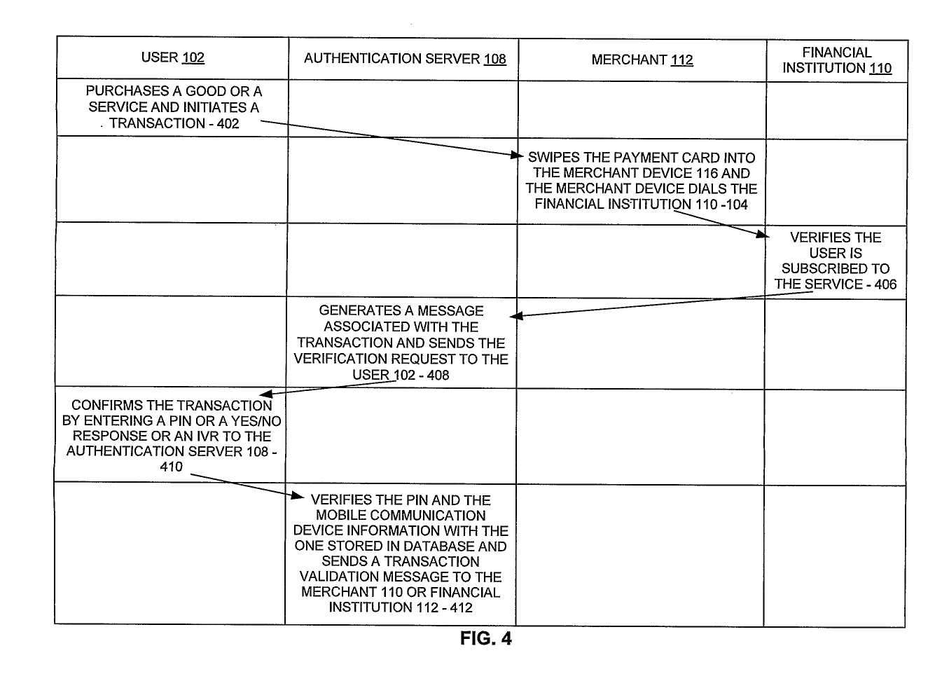

FIG. 4 is an interaction diagram of a face-to-face transaction between the user 102 of FIG. 1, and the merchant 112 of FIG. 1 according to an embodiment herein. FIG. 4 illustrates a series of operations carried out during various stages of interaction between the user 102, the merchant 112, the authentication server 108 and the financial institution 110. In operation 402, the user 102 purchases a good or a service and initiates a transaction.

In one embodiment, the transaction is initiated by using the payment card (e.g., the credit card or the debit card). In operation 404, the merchant 112 swipes the payment card into the merchant device 116. The merchant device 116 dials the financial institution 110. In one embodiment, the merchant device 116 may also dial the authentication server in parallel. In operation 406, the financial institution 110 checks whether the user 102 is subscribed to the service.

In one embodiment, the financial institution 110 checks whether the user 102 is subscribed to real time security validation service. If the user 102 is subscribed to the service, the financial institution 110 communicates with the authentication server 108. In operation 408, the authentication server 108 generates a verification message (e.g., transaction details and request for entering the PIN) associated with the transaction and sends the verification message to the user 102. In operation 410, the user 102 confirms the transaction by entering the PIN, and sending back to the authentication server 108.

In one embodiment, the user 102 may just type YES/NO response and send back to the authentication server 108. In another embodiment, the user 102 may perform the above step with an IVR by a speech (e.g., YES/NO or by pressing designated keys on the mobile communication device 104A-B). In yet another embodiment, the client application also sends the mobile communication device information (e.g., the IMEI information, the SIM information, the contact information, and/or the Bluetooth unique identifier information) to the authentication server 108 when the user 102 confirms the payment card transaction.

In operation 412, the authentication server 108 verifies the PIN and the mobile communication device information (e.g., using the matching module 210 of FIG. 2) with the one stored in the database 202 of the authentication server 108 of FIG. 1. If the PIN matches, then the authentication server 108 generates a transaction validation message indicating the status of the transaction (e.g., transaction completed) and sends the transaction validation message to the financial institution 110 or the merchant 112.

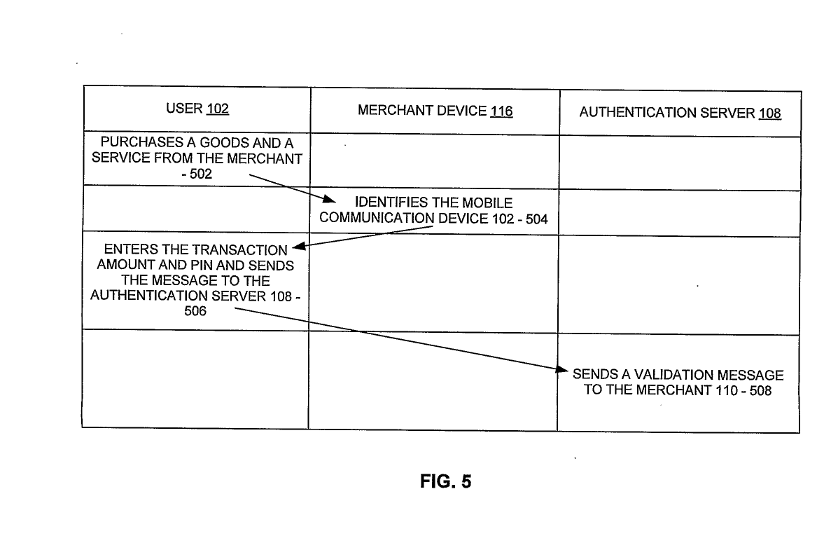

FIG. 5 is an interaction diagram illustrating a process of transaction through a Bluetooth mechanism according to an embodiment herein. In one embodiment, the transaction process is carried out if the merchant device 116 associated with the merchant 112 at the point of sale (POS) and the mobile communication device 104A-B associated with the user 102 have a Bluetooth application. In another embodiment, the transaction process is also carried out if the merchant device 116 associated with the merchant 112 at the point of sale and the mobile communication device 104 associated with the user 102 have an infrared application. In operation 502, the user 102 purchases a goods and a service from the merchant 112.

In operation 504, the merchant device 116 identifies the mobile communication device 104A-B with a Bluetooth unique identifier number (e.g., if the Bluetooth application in the mobile communication device 104A-B and the merchant device are turned ON). In one embodiment, the merchant device 116 identifies the mobile communication device 104A-B if the infrared application in the mobile communication device 104A-B and the merchant device 116 are turned ON).

The client application 114 residing on the mobile communication device 104A-B prompts the user 102 to enter the transaction amount and the user 102 and the PIN sends to the authentication server 108 in the operation 506. In operation 508, the authentication server 108 sends a validation message (e.g., transaction completed) to the merchant 112. The authentication server 108 may then locate the user 102 based on the information associated with the transaction (e.g., PIN code of the merchant 112) and deliver targeted advertisements (e.g., buy movie tickets and get free gift coupon's).

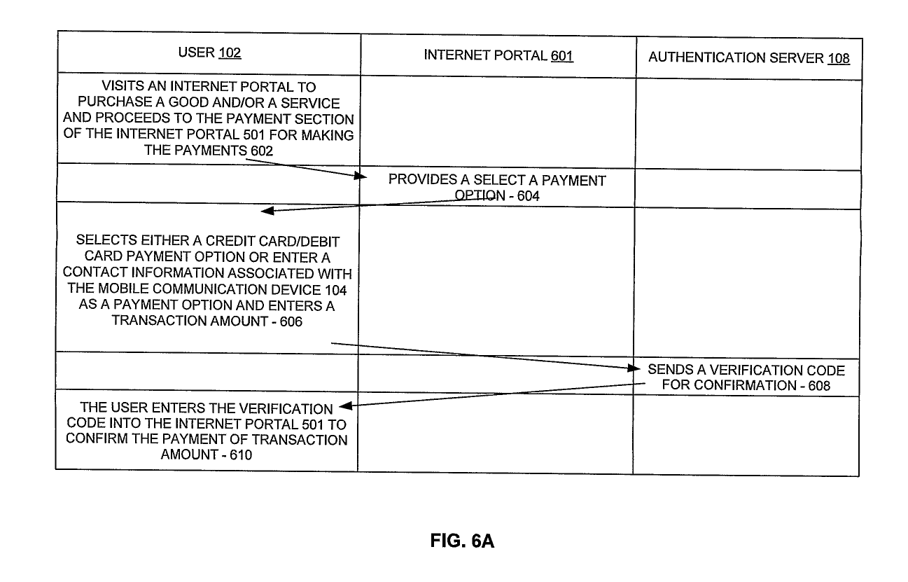

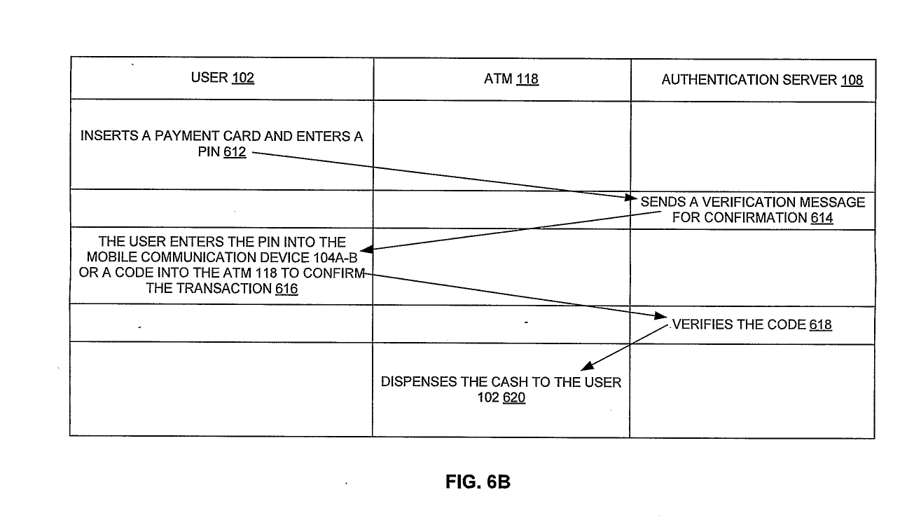

FIG. 6A is an interaction diagram of a non face-to-face transaction according to an embodiment herein. FIG. 6A illustrates a series of operations carried out during various stages of interaction between the user 102, an internet portal 601, the authentication server 108. In operation 602, the user 102 visits an internet portal 601 (e.g., www.xyz.com) to purchase a good and/or a service (e.g., movie tickets) and proceeds to the payment section of the internet portal 501 for making the payments.

In operation 604, the internet portal 601 provides a select a payment option. In operation 606, the user 102 selects the credit card as a payment option. In one embodiment, the user 102 may select his/her contact information (e.g., mobile number) as a payment option. In another embodiment, the contact information is associated with the payment card.

For example, the user 102 may enter the number associated with the credit card and the transaction amount. In another embodiment, the user 102 may enter contact information (e.g., mobile number) associated with the mobile communication device 104A-B of the user 102. In operation 608, the authentication server 108 sends a verification message (e.g., a code) to the user 102 for confirmation. In one embodiment, the verification message is generated dynamically and sent to the mobile communication device 104A-B associated with the user 102 via at least one of a SMS channel, a MMS channel or an IVR. In operation 610, the user 102 enters the code into the internet portal 601 to confirm the payment of transaction amount. For an example embodiment, the user 102 may respond a YES/NO or press 1 or 2 as a designated key on the mobile communication device 104A-B via the IVR, the SMS channel or the MMS channel.

FIG. 6B is an interaction diagram of the user 102 performing a transaction with the ATM 118 of FIG. 1 according to an embodiment herein. FIG. 6B illustrates a series of operations carried out during various stages of interaction between the user 102, the ATM 118, and the authentication server 108. In operation 612, the user 102 inserts a payment card in the ATM 118 and enters a PIN. In one embodiment, the PIN is the code generated by the message generating module 208. In operation 614, the authentication server 108 sends a verification code to the mobile communication device 104A-B. In operation 616, the user 102 enters a verification code (e.g., YES/NO) in the mobile communication device 104A-B and/or a PIN into the ATM 118. In one embodiment, the client application 114 sends the information associated with the mobile communication device 104A-B to the authentication server 108 in parallel. In operation 618, the authentication server 108 matches the verification message and the information associated with the mobile communication device 104A-B (e.g., using the matching module 210 of FIG. 2) with the one stored in the database 202. In operation 620, the ATM 118 dispenses the cash to the user 102.

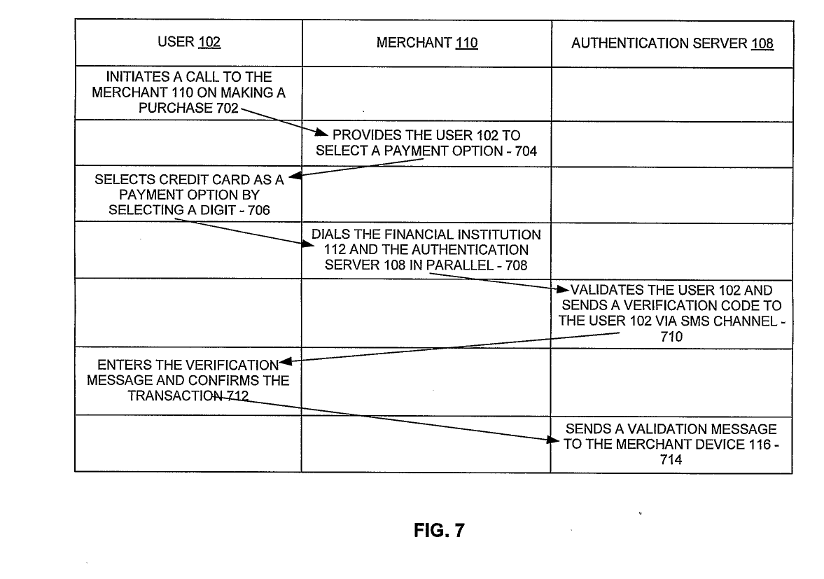

FIG. 7 is an interaction diagram between the user 102 of FIG. 1 and the merchant 112 of FIG. 1 illustrating an alternative embodiment of a non-face to face payment according to an embodiment herein. In one embodiment, the non-face to face payment is an Interactive Voice Response (IVR). In operation 702, the user 102 initiates a call to the merchant 112 on making a purchase. In operation 704, the merchant 112 provides the user 102 to select a payment option. In operation 706, the user 102 selects a digit (e.g., 1) as the credit card option for making payments.

In another embodiment, the user 102 may make payments by entering the contact information of the mobile communication device 104A-B associated with the user 102. In operation 708, the merchant 112 dials the financial institution 110 and may dial the authentication server 108 in parallel. In operation 710, the authentication server 108 validates the user 102 and generates a verification message (e.g., transaction amount and request for a PIN or a code generated by the message generating module 208) and sends to the user 102 via SMS channel, a MMS channel, or an IVR. In operation 712, the user 102 enters the PIN (e.g., or the code) and confirms the transaction. In operation 714, the authentication server 108 sends a validation message (e.g., transaction completed) to the merchant device 116.

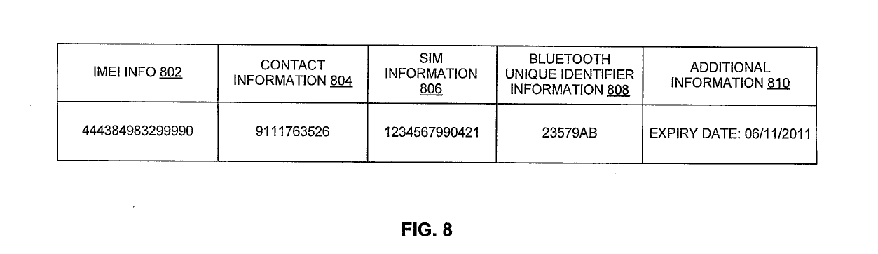

FIG. 8 is a table view of a database of the payment card according to an embodiment herein. The database includes an IMEI information field 802, a contact information field 804, a SIM information field 806, a Bluetooth unique identifier information 808, and an additional information field 810 associated with the financial institution 110. The IMEI information field 802 contains the IMEI information (e.g., 444384983299990) associated with the mobile communication device 104 of the user 102. The contact information field 804 contains the contact information (e.g., a mobile number 9111763526) of the user 102 associated with the mobile communication device 104A-B. In one embodiment, the contact information is a mobile communication device number.

The SIM information field 806 contains the SIM information (e.g., 1234567990421) associated with the mobile communication device 104A-B of the user 102. The Bluetooth unique identifier information field 808 may contain a Bluetooth unique identifier number (e.g., 23579AB) associated with the mobile communication device 104A-B. The additional information field 808 may contain the information associated with the payment card (e.g., such as expiry date of the payment card: Jun. 11, 2011) etc.

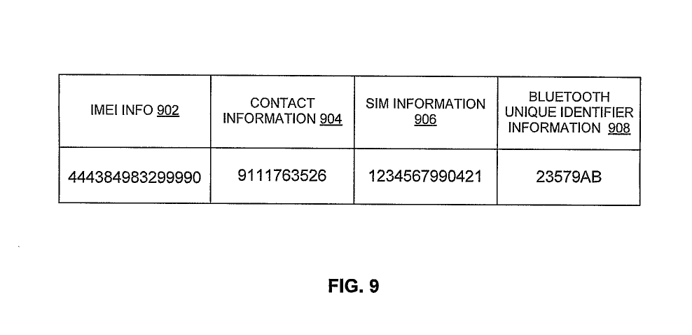

FIG. 9 is a table view of the database 202 of the authentication server 108 of FIG. 1 according to an embodiment herein. The database 202 includes an IMEI information field 902, a contact information field 904, a SIM information field 906, and a Bluetooth unique identifier information field 908 associated with the mobile communication device 104A-B of the user 102. The IMEI information field 902 contains the IMEI information (e.g., 444384983299990) associated with the mobile communication device 104A-B of the user 102.

The contact information field 904 contains the contact information (e.g., mobile no: 9111763526) of the user 102 associated with the mobile communication device 104A-B. The SIM information field 906 contains the SIM information (e.g., 1234567990421) associated with the mobile communication device 104A-B of the user 102. The Bluetooth unique identifier information field 908 may contain a Bluetooth unique identifier number (e.g., 23579AB) associated with the mobile communication device 104A-B.

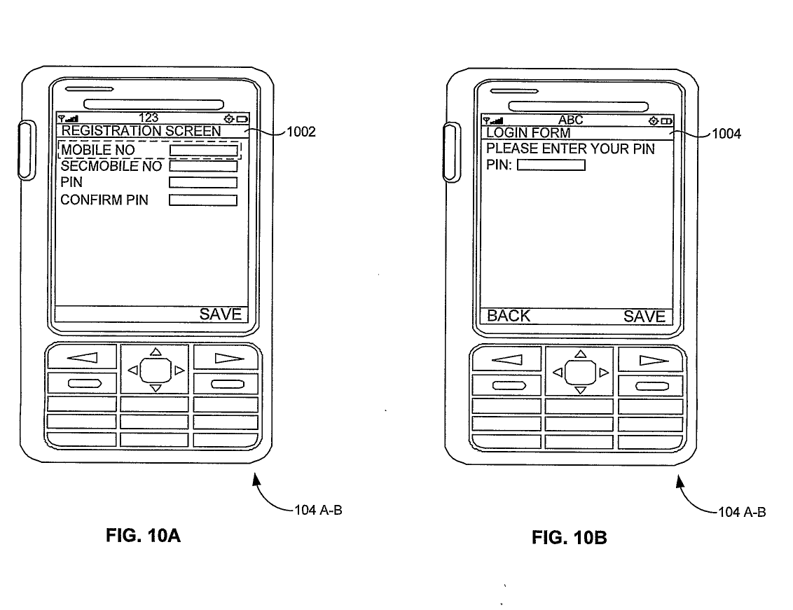

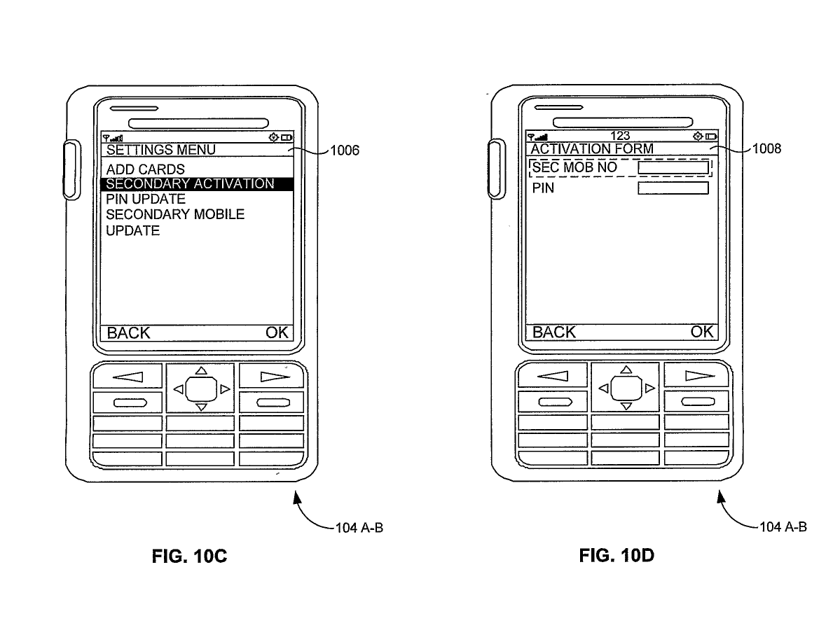

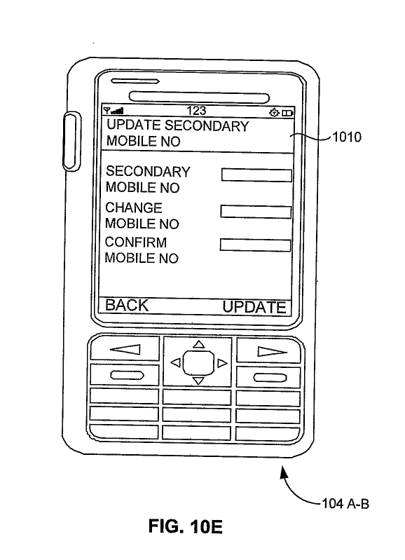

FIG. 10A through 10E is a user interface view illustrating a method of registering and activating the mobile communication device 104A-B to perform an electronic card transaction according to an embodiment herein. The FIG. 10A through 10D includes a registration form field 1002, a login field 1004, a settings menu field 1006, an activation form field 1008, and a update secondary mobile communication device field 1010. The registration screen field 1002 includes a primary mobile communication device number field, a secondary mobile communication device number field, a PIN field, and a confirm field.

The user 102 enters information associated with the primary mobile communication device 104A and the secondary mobile communication device 104B and confirms the PIN by entering into a PIN field and the confirm field of FIG. 10A. The login field 1004 of FIG. 10B allows the user 102 to login to the application by entering associated with the transaction. The settings menu field 1006 of FIG. 10C provides the user 102 various options. The options may include add cards, secondary mobile communication device 104B activation, a pin update, and a secondary mobile communication device update. The user 102 clicks on the secondary activation option to activate the secondary mobile communication device 104B and the activation form field 1008 is displayed as shown in FIG. 10D.

The user interface view of the mobile communication device 104A-B allows the user 102 to update the information associated with the secondary mobile communication device 104B. The update secondary mobile communication device 104B field allows the user 102 to enter mobile communication device information associated with the secondary mobile communication device 104B. The updating the secondary mobile communication device 104B is shown in FIG. 10E.

In one embodiment, the mobile communication device information may include a secondary mobile communication device number, a change mobile communication device number and a confirm the mobile communication number. The user 102 confirms the activation of the secondary mobile communication device 104B by entering the mobile number in the secondary mobile communication device number field and in the confirm mobile number field. The user 102 may click on the update button to confirm an update of the information associated with the secondary mobile communication device 104B.

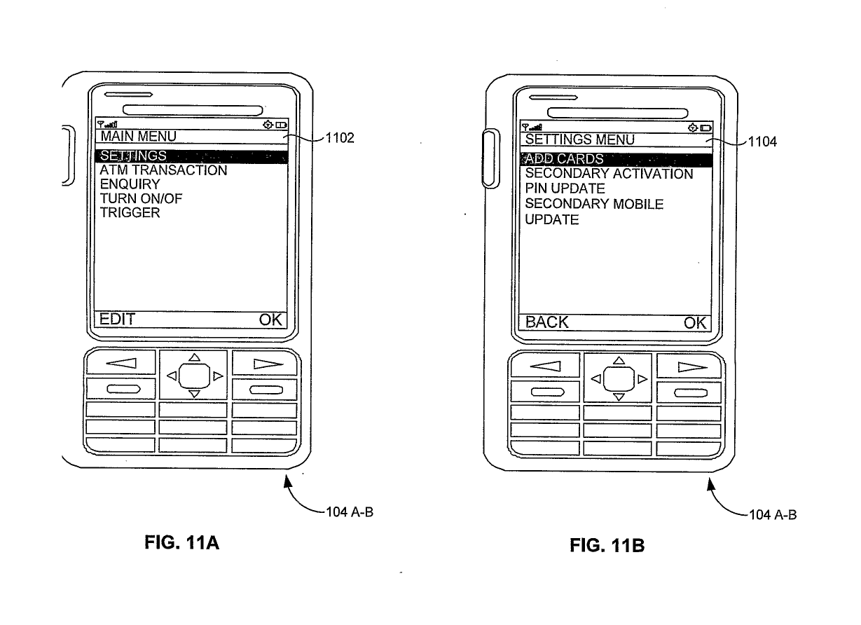

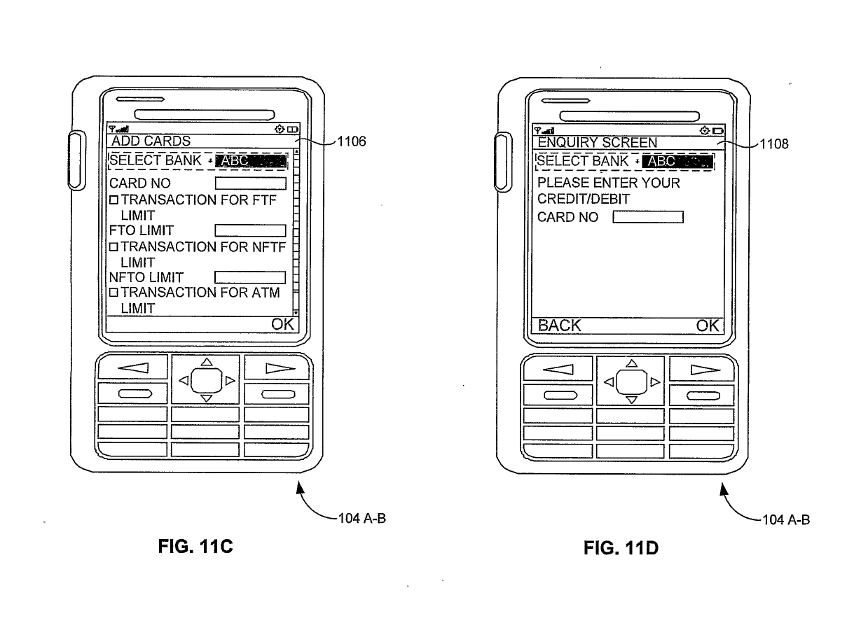

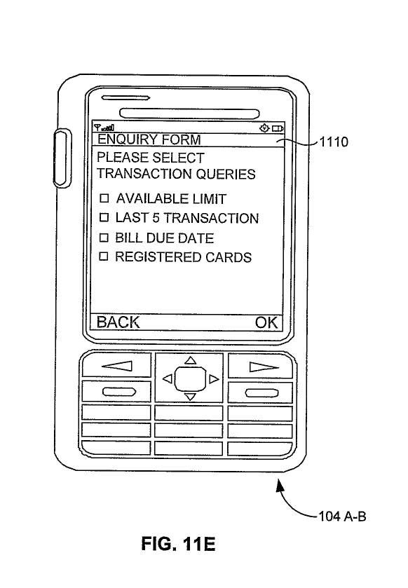

FIG. 11A through 11E is a user interface view of the client application 114 of the mobile communication device 104A-B according to an embodiment herein. The user interface view includes a settings field 1104 within a main menu screen 1102 of the mobile communication device 104A-B. The settings field 1104 includes a add cards field 1106. The add card field 1106 includes a select a bank field, a card number field, a transaction limit field for a face to face transaction limit field, a non face to face transaction limit field and a transaction for ATM field.

The add cards field 1106 allows the user 102 to enter and select the bank for a transaction. In addition, the settings field 1104 within the main menu screen field 1102 allows the user 102 to set transaction limits for the face to face transaction, a non face to face transaction, and a transaction for an ATM. The user 102 may confirm the inputs into the field by clicking on the designated key on the mobile communication device 104A-B (e.g., OK button). In addition, the main menu field allows the user 102 to check the transaction queries through an enquiry screen field 1108 and enquiry form field 1110.

The user 102 when enters the financial institution details and the payment card number and clicks OK button, the user interface of FIG. 10D displays a user interface having the enquiry form field 1110 as shown in FIG. 11E. In one embodiment, the transaction queries include available financial limit, last 5 transaction performed, bill due date, and registered cards. The user 102 may opt for any of the queries to view information associated with the query of user's interest.

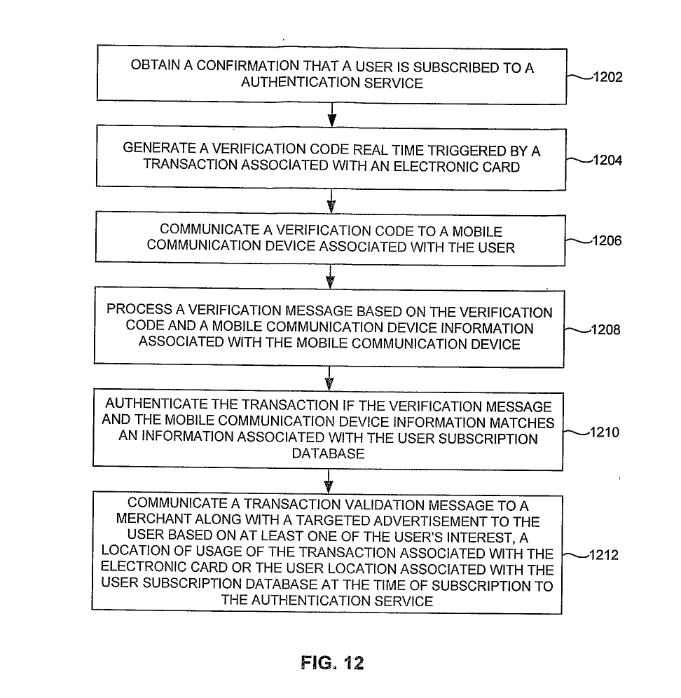

FIG. 12 is a process flow illustrating a method authenticating real time a transaction associated with an electronic card performed by the user 102 subscribed to an authentication service having a user subscription database (e.g., the database 202) on the authentication server 108 according to an embodiment herein. In step 1202, a confirmation is obtained that the user 102 is subscribed to a authentication service. In one embodiment, the confirmation is obtained from the financial institution 110. In step 1204, a verification code is generated by the authentication server 108 real time triggered by a transaction associated with an electronic card. In step 1206, a verification code is communicated to the mobile communication device 104A-B associated with the user 102 by the authentication server. In step 1208, a verification message is processed based on the verification code and a mobile communication device information associated with the mobile communication device 104A-B.

In step 1210, the transaction is authenticated if the verification message and the mobile communication device information matches an information associated with the user subscription database (e.g., the database 202 of FIG. 2). In step 1212, a transaction validation message is communicated to the merchant 112 along with a targeted advertisement to the user 102 based on at least one of the user's interest, a location of usage of the transaction associated with the payment card or the user location associated with the user subscription database at the time of subscription to the authentication service may be communicated to the user 102 through the mobile communication device 104A-B. In addition, the mobile communication device 104B may be identified as a secondary mobile communication device based on a match between a user login information associated with the mobile communication device 104A-B and a user login information associated with the secondary mobile communication device 104B stored in the user subscription database (e.g., the database 202 of FIG. 2).

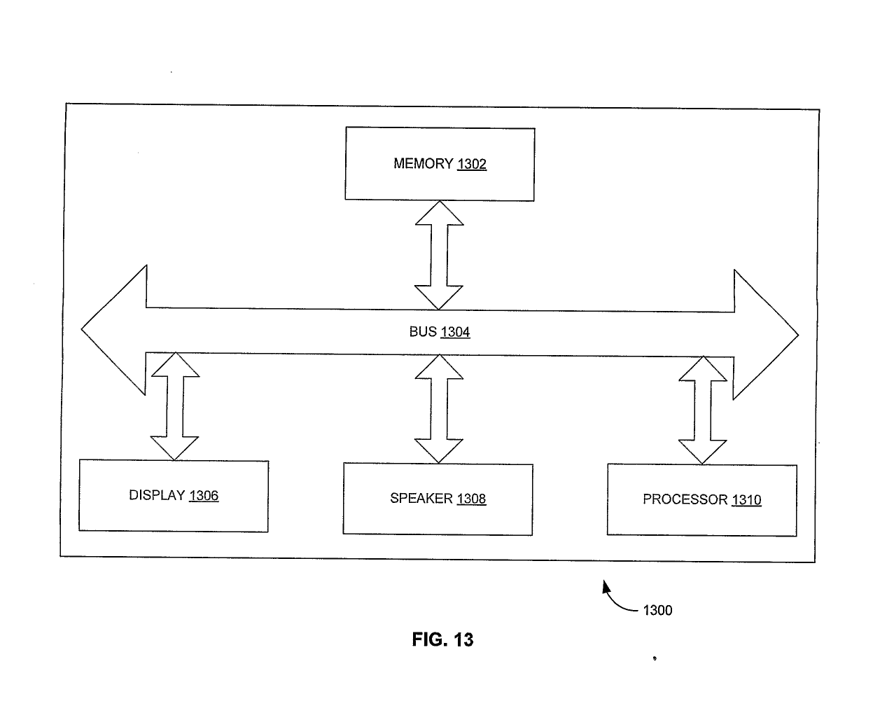

FIG. 13 illustrates an exploded view of the mobile communication device 104A-B of FIG. 1 having an a memory 1302 having a computer set of instructions, a bus 1304, a display 1306, a speaker 1308, and a processor 1310 capable of processing a set of instructions to perform any one or more of the methodologies herein, according to an embodiment herein. The processor 1310 may also enable digital content to be consumed in the form of video for output via one or more displays 1306 or audio for output via speaker and/or earphones 1308. The processor 1310 may also carry out the methods described herein and in accordance with the embodiments herein.

Digital content may also be stored in the memory 1302 for future processing or consumption. The memory 1302 may also store program specific information and/or service information (PSI/SI), including information about digital content (e.g., the detected information bits) available in the future or stored from the past. The user 102 of the mobile communication device 104A-B may view this stored information on display 1306 and select an item of for viewing, listening, or other uses via input, which may take the form of keypad, scroll, or other input device(s) or combinations thereof. When digital content is selected, the processor 1310 may pass information. The content and PSI/SI may be passed among functions within the mobile communication device 104A-B using bus 1304.

The techniques provided by the embodiments herein may be implemented on an integrated circuit chip (not shown). The chip design is created in a graphical computer programming language, and stored in a computer storage medium (such as a disk, tape, physical hard drive, or virtual hard drive such as in a storage access network). If the designer does not fabricate chips or the photolithographic masks used to fabricate chips, the designer transmits the resulting design by physical means (e.g., by providing a copy of the storage medium storing, the design) or electronically (e.g., through the Internet) to such entities, directly or indirectly.

The stored design is then converted into the appropriate format (e.g., GDSII) for the fabrication of photolithographic masks, which typically include multiple copies of the chip design in question that are to be formed on a wafer. The photolithographic masks are utilized to define areas of the wafer (and/or the layers thereon) to be etched or otherwise processed.

The resulting integrated circuit chips can be distributed by the fabricator in raw wafer form (that is, as a single wafer that has multiple unpackaged chips), as a bare die, or in a packaged form. In the latter case the chip is mounted in a single chip package (such as a plastic carrier, with leads that are affixed to a motherboard or other higher level carrier) or in a multichip package (such as a ceramic carrier that has either or both surface interconnections or buried interconnections).

In any case the chip is then integrated with other chips, discrete circuit elements, and/or other signal processing devices as part of either (a) an intermediate product, such as a motherboard, or (b) an end product. The end product can be any product that includes integrated circuit chips, ranging from toys and other low-end applications to advanced computer products having a display, a keyboard or other input device, and a central processor.

The embodiments herein can take the form of an entirely hardware embodiment, an entirely software embodiment or an embodiment including both hardware and software elements. The embodiments that are implemented in software include but are not limited to, firmware, resident software, microcode, etc.

Furthermore, the embodiments herein can take the form of a computer program product accessible from a computer-usable or computer-readable medium providing program code for use by or in connection with a computer or any instruction execution system. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

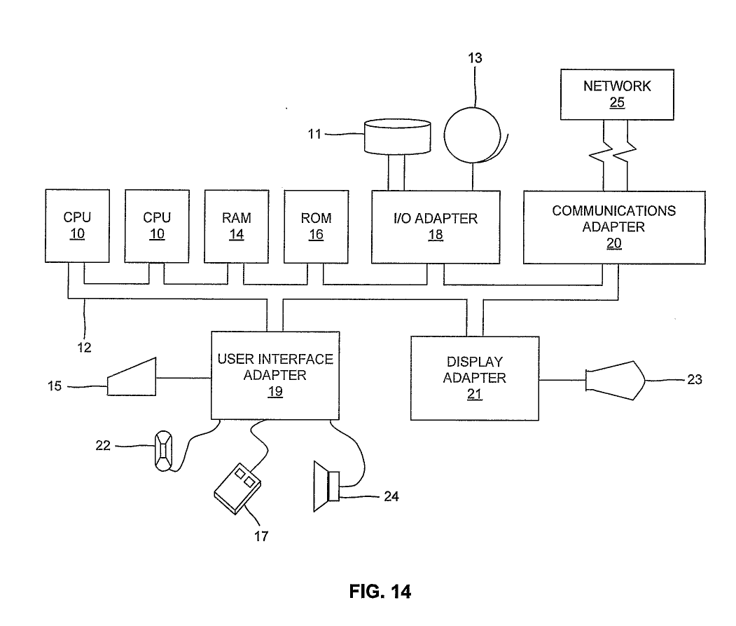

A representative hardware environment for practicing the embodiments herein is depicted in FIG. 14. This schematic drawing illustrates a hardware configuration of an information handling/computer system in accordance with the embodiments herein. The system comprises at least one processor or central processing unit (CPU) 10. The CPUs 10 are interconnected via system bus 12 to various devices such as a random access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The system can read the inventive instructions on the program storage devices and follow these instructions to execute the methodology of the embodiments herein.

The system further includes a user interface adapter 19 that connects a keyboard 15, mouse 17, speaker 24, microphone 22, and/or other user interface devices such as a touch screen device (not shown) to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example. The system for real time authentication of payment cards does not require the user having to provide a bank account number, credit card number, and/or authorization code to a 3rd party service provider, or allow the 3rd party to debit funds directly from the account. Further, tie-ups with banks of the merchants and storing merchant profiles is not required. The system does not handle the financial institution itself but integrates well into the existing system of payment card transactions for which it provides enhanced security.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. A method of authenticating real time a transaction associated with an electronic card, said transaction performed by a user subscribed to an authentication service having a user subscription database on a authentication server, said method comprising:
obtaining a confirmation that said user is subscribed to said authentication service;
generating a verification code real time triggered by said transaction associated with said electronic card;
communicating said verification code to a mobile communication device associated with said user;
processing a verification message based on said verification code and a mobile communication device information associated with said mobile communication device, wherein said verification message and said mobile communication device information are obtained from said mobile communication device real time; and
authenticating said transaction if said verification message and said mobile communication device information matches an information associated with said user subscription database.

2. The method of claim 1, wherein said authentication process further comprising communicating a transaction validation message to a merchant along with a targeted advertisement to said user based on at least one of said user's interest, a location of usage of said transaction associated with said electronic card or said user location associated with said user subscription database at the time of subscription to said authentication service.

3. The method of claim 1, further comprising identifying said mobile communication device as a secondary mobile communication device based on a match between a user login information associated with said mobile communication device and a user login information associated with said secondary mobile communication device stored in said user subscription database.

4. The method of claim 3, wherein said mobile communication device and said secondary mobile communication device comprises a client application.

5. The method of claim 1, wherein said mobile communication device information is at least one of a International Mobile Equipment Identity (IMEI) information, a Subscriber Identity Module (SIM) information, a Bluetooth unique identifier information, a infrared identifier information, or a mobile communication device number.

6. The method of claim 1, wherein said electronic card comprising at least one of a International Mobile Equipment Identity (IMEI) information, a Subscriber Identity Module (SIM) information, a Bluetooth unique identifier information, a infrared identifier information, or a mobile communication device number.

7. The method of claim 1, wherein said mobile communication device and said secondary mobile communication device is at least one of a GSM phone, a UMTS phone, a CDMA phone, a CDMA 2000 phone, a PDC, a TDMA phone, a smart phone, a PDA (Pocket Digital Assistant), a touch sensitive device, a handheld device, or a wireless device.

8. The method of claim 1, wherein said verification code and said verification message is communicated via at least one of an SMS channel, an MMS channel, a GPRS data channel, a CDMA data channel, a Bluetooth channel, an infrared channel, an Interactive Voice Response (IVR), or a 3G network.

9. The method of claim 1, wherein said transaction associated with said electronic card is one of a face to face transaction or a non face to face transaction, said transaction associated with electronic card is one of a credit card transaction or a debit card transaction.

10. The method of claim 9, wherein said credit card transaction and said debit card transaction is one of a cash withdrawal transaction with an ATM.

11. The method of claim 4, wherein said client application associated with said mobile communication device and said secondary mobile communication device sends said mobile communication device information associated with said mobile communication device and said secondary mobile communication device to said authentication server.

12. A program storage device readable by computer, tangibly embodying a program of instructions executable by said computer to perform a method of authenticating an electronic card transaction real time, said transaction performed by a user subscribed to an authentication service having a user subscription database on said authentication server, said method comprising:
processing a verification code from said authentication server on said transaction being performed; and
communicating a verification message based on said verification code and a mobile communication device information associated with a mobile communication device associated with said user on said user subscription database, wherein said verification message and said mobile communication device information are communicated simultaneously to said authentication server real time.

13. The program storage device of claim 12, wherein said transaction associated with said electronic card is one of a face to face transaction or a non face to face transaction, said transaction is at least one of a credit card transaction or a debit card transaction with an ATM.

14. The program storage device of claim 12, wherein said mobile communication device comprises a client application.

15. The program storage device of claim 12, wherein said mobile communication device information is at least one of a International Mobile Equipment Identity (IMEI) information, a Subscriber Identity Module (SIM) information, a Bluetooth unique identifier information, a infrared identifier information, or a mobile communication device number associated with said user.

16. The program storage device of claim 12, wherein said electronic card comprising at least one of a International Mobile Equipment Identity (IMEI) information, a Subscriber Identity Module (SIM) information, a Bluetooth unique identifier information, a infrared identifier information, or a mobile communication device number associated with said user.

17. A mobile communication device to perform a transaction associated with an electronic card, said mobile communication device comprising a client application, said transaction performed by a user subscribed to an authentication service having a user subscription database on a authentication server, said client application comprising:
a confirmation module to process a verification message on receiving a verification code from said authentication server associated with said mobile communication device and said secondary mobile communication device to said authentication sever real time; and
a transmitting module to transmit said verification message and said information associated with said mobile communication device and said secondary mobile communication device simultaneously to said authentication server real time.

18. The mobile communication device of claim 17, wherein said client application further comprising a preference module to set a limit associated with said transaction.

19. The mobile communication device of claim 17, wherein said information is sent via at least one of an SMS channel, an MMS channel, a GPRS data channel, a CDMA data channel, a Bluetooth channel, an infrared channel, an Interactive Voice Response (IVR), or a 3G network, wherein said IVR is one of a YES/NO response, or a designated key associated with said mobile communication device and said secondary mobile communication device.

20. The mobile communication device of claim 17, wherein said transaction is one of a face to face transaction or a non face to face transaction, said transaction is at least one of a credit card transaction or a debit card transaction with an ATM.
